(19) United States
(12) Patent Application Publication
(10) Pub. No.: US 2005/0091286 A1
(43) Pub. Date: Apr. 28, 2005

(54) Tracking and replicating file system changes

(76) Inventors: Adam Fineberg, Saratoga, CA (US); Akmal Khan, Novato, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/941,058

(22) Filed: Sep. 13, 2004

Related U.S. Application Data
(60) Provisional application No. 60/502,299, filed on Sep. 12, 2003.

(51) Int. Cl. G06F 12/00

(52) U.S. Cl. 707/200

(57) ABSTRACT

Management of file system changes among multiple instances is provided. Changes to file systems include addition, modification, and removal of files. A modification sentry monitors file system operations taking place on the source file system. When a file is modified on the source file system, the modification sentry makes a corresponding entry in the repository. If a file is added, the file name and file contents are stored in the repository. If a file is modified, the file name, modification, and additionally the entire file are stored in the repository. If a file is removed, only the name of the file is stored in the repository. Logic is also provided for propagating modifications to special-type files. To propagate the modifications to target file systems, a file system update engine of packages a vector derived from the repository for application to other file systems.

### CROSS-REFERENCE TO RELATED APPLICATIONS

This application claims the benefit under 35 U.S.C. 119(e) of U.S. Provisional Application No. 60/502,299, filed on Sep. 12, 2003, and incorporated by reference herein in its entirety.

This application is also related to U.S. patent application Ser. No. 10/841,959, filed on May 7, 2004, and incorporated by reference herein in its entirety.

### FIELD OF THE INVENTION

The present invention relates generally to managing file systems. In particular, the present invention is directed toward managing and replicating changes in file systems across multiple computer systems.

### DESCRIPTION OF THE RELATED ART

Many enterprises have a number of computers running instances of the same file system. For example, an enterprise may want to have its web server replicated among five or six different servers in order to perform load balancing. In these kinds of cases, whenever a modification is made to one of the servers, it must be replicated among all of the other servers. A modification may include a version upgrade to a software component, new drivers, changes to authorized user information, or any of a variety of other changes that regularly must be made to a file system in order to keep it functioning optimally.

Further, if a new server is brought online, changes made to the other systems will have to be applied, sometimes sequentially, to the new system in order to have it in the same state as the other servers. This can be a time consuming process occupying a significant portion of valuable IT department resources.

The problem of managing file system changes is not restricted to replicated servers. It is often the case that a person or organization wants to repeat modifications made to a first file system on a second file system, even though the two file systems may not have been identical to begin with—that is, the two systems may have different directory structures, different user accounts, different loaded applications, etc. Conventionally, propagating changes to other file system instances has required making the target file systems identical to the source file system, which in this case would destroy any differing data present on the target file systems—not an optimal solution.

Accordingly, there is a need for an effective way to manage file system changes among multiple instances.

### SUMMARY OF THE INVENTION

The present invention enables the managing of file system changes among multiple instances. Changes to file systems include addition of files, modification of files, and removal of files. A system of the present invention includes a modification sentry for determining changes to a source file system, and a repository for storing the tracked changes. In one embodiment, the system resides on the source file system itself, while in alternative embodiments the system resides on the target file system, or on a separate file system.

The modification sentry monitors file system operations taking place on the source file system. When a file is added, changed or removed from the source file system, the modification sentry makes a corresponding entry in the repository. If a file is added, the file name and file contents are stored in the repository. If a file is modified, the file name, modification, and additionally the entire file are stored in the repository. If a file is removed, preferably only the name of the file is stored in the repository.

The present invention also includes logic for propagating modifications to special-type files such as, in the case of Linux for example, the user account files, as well as files connected either by symbolic or hard links.

To deploy the tracked modifications to the target file systems, a file system update engine of the present invention preferably packages a vector derived from the repository in a manner allowing it to be conveniently applied to other instances' file systems. In one embodiment, the vector is packaged as an RPM package. When executed on the target file system, the RPM package updates the file system by performing the specified modifications.

In one embodiment, the present invention creates one or more tarballs (i.e., archive files) to store the collection of data describing the vector. This tarball can be applied directly to the target file system. In another embodiment, such as when a Linux implementation is in use, the present invention transforms the tarballs into RPM format (RedHat Package Manager format), allowing subsequent installation by using the Linux “rpm” program.

### BRIEF DESCRIPTION OF THE DRAWINGS

FIG. 1 is a block diagram of a system in accordance with an embodiment of the present invention.

FIG. 2 is an illustration of entries in a repository in accordance with an embodiment of the present invention.

FIG. 3 is a flowchart of a method in accordance with an embodiment of the present invention.

FIG. 4 is a diagram illustrating the modification of hard links in accordance with an embodiment of the present invention.

The figures depict preferred embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

General File System Architecture

As will be apparent to those of skill in the art from this disclosure, the present invention has application to a variety of system architectures and network layouts. In general, one or more computer systems execute an operating system which in one embodiment is the Linux operating system. The computer systems can include PDAs, personal computer systems, server computer systems, mainframe computer systems, etc. Some computer systems execute a single instance of the operating system. Other computer systems execute multiple instances of the operating system on virtual machines provided by the computer system, so that each operating system instance appears to be executing on a dedicated computer system. These operating system instances, regardless of the underlying computer hardware, are referred to as “managed instances.”

A file system module executing on at least one of the computer systems provides a file system that holds files used by the managed instances. The files include executable files and data files. The executable files contain executable code and are executed by the managed instances to perform certain functions. The data files contain data used by the managed instances while executing the executable files. The managed instances frequently modify the data files. The structure of the file system is typically one involving files laid out in directories and subdirectories, branching out from a root directory.

Solutions exist for controlling and operating managed instances of file systems such as described above. One such solution is the MapFS file system available from Levanta, Inc., of San Francisco, Calif. An extensive description of the way in which such a solution operates can be found in U.S. patent application Ser. No. 10/841,959, filed on May 7, 2004, and incorporated by reference herein in its entirety. MapFS traps file system operations and either allows them to execute as called, or else redirects the operation, for example in the case of a write call to a read-only file system. Because MapFS intercepts all file system operations from a source file system, it provides an effective way of notifying the modification sentry of the present invention of those file system modifications. Those of skill in the art will recognize, however, that file system modifications can also be detected by other means, for example by walking the entire file system and comparing each file to a previous version of the file.

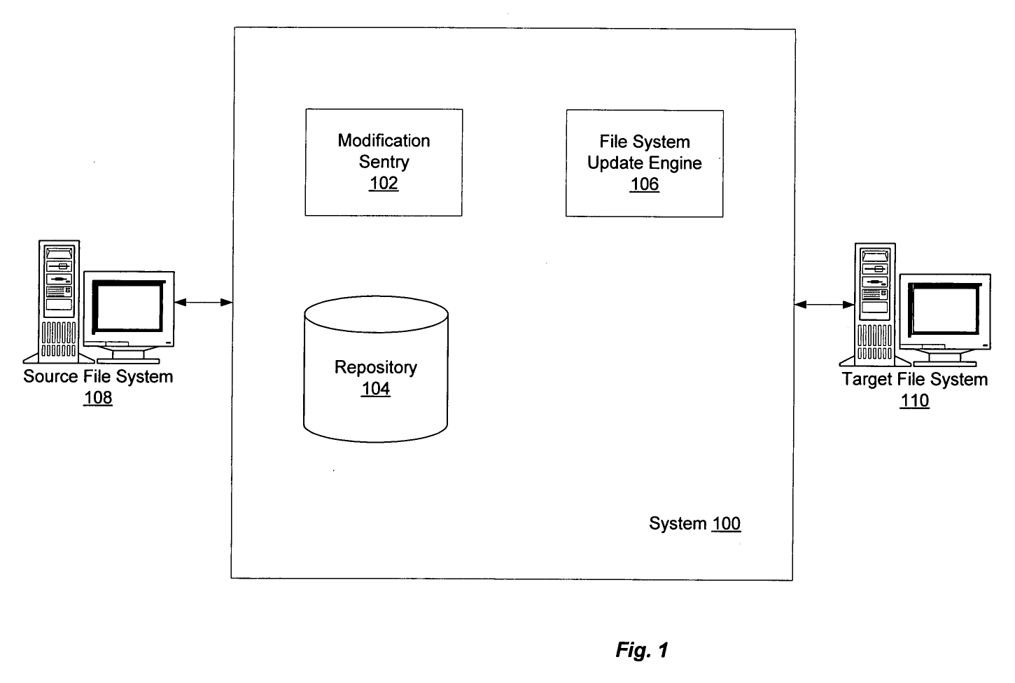

Referring now to FIG. 1, there is shown a block diagram of a system in accordance with the present invention. FIG. 1 includes a modification sentry 102, a repository 104, and a file system update engine 106. Also shown in FIG. 1 are a source file system 108 and a target file system 110. As noted previously, system 100 in one embodiment resides on source file system 108, though in alternative embodiments it resides on a target file system 110, or on a separate file system. Further, although in FIG. 1 only a single target file system 110 is depicted, those of skill in the art will appreciate that any number of target file systems 110 could be updated in a similar manner as described here.

Modification sentry 102 monitors modifications to source file system 108 and stores records of those modifications in repository 104. In one embodiment, modification sentry 102 receives notification of file system modifications from an operating system such as MapFS. In an alternative embodiment, modification sentry 102 periodically examines the source file system 108 to compare a current state of files against a prior known state of files to determine which files have been modified. File system update engine 106 propagates the modifications stored in repository 104 to target file system 110.

In one embodiment, repository 104 includes a separate log file for each file on the file system that has been modified; in an alternative embodiment a single file or even an arbitrary number of files are kept by repository 104 to maintain records of file system operations.

In a preferred embodiment, file system modifications include adding a previously non-existent file, modifying an existing file, and removing (deleting) a file. Again, this description assumes a Linux implementation of a file system for ease of explanation, though it will be readily clear to those of skill in the art that the present invention is well suited to most operating systems, and should not be restricted to the described Linux implementation. For example, the present invention could also be implemented on an NTFS file system.

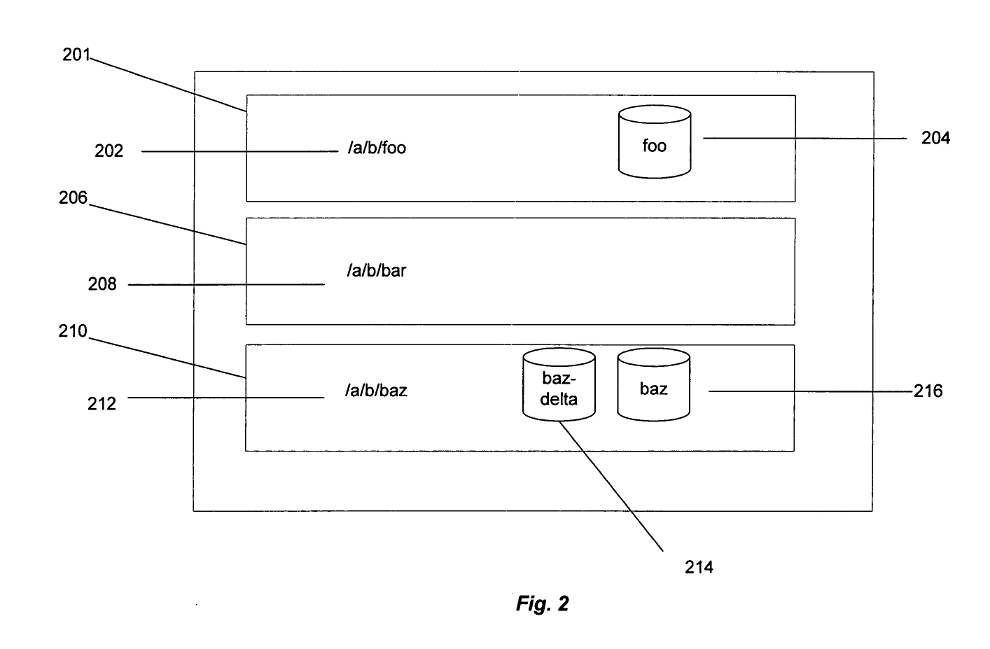

In a preferred embodiment, and referring now to FIG. 2, when a file is added to source file system 108, an entry 201 is added to repository 104. Preferably, the entry includes a pathname 202 and the file 204 itself. As will be appreciated by those of skill in the art, the file 204 is included in the change record because since it is a new file being added to source file system 110, by definition it did not previously exist and thus must be included in its entirety.

To remove a file in a preferred embodiment, an entry 206 is added to repository 104 of the deletion. In a preferred embodiment, the record includes only the pathname 208 of the deleted file, and not the file itself—since the file is being deleted, there is no reason to include any of its data.

If a file is being modified on source file system 108, an entry 210 is made to the repository 104 including the pathname 212; modifications made 214, i.e. the delta between the file as it existed originally and its current state; and the file itself 216. Those of skill in the art will appreciate that because there is no guarantee that the file exists on the target file system 110, including the file in repository 104 allows the file to be deployed on the target file system either by applying the modifications to the file if the file already exists, or else by copying the file from the repository if it does not already exist.

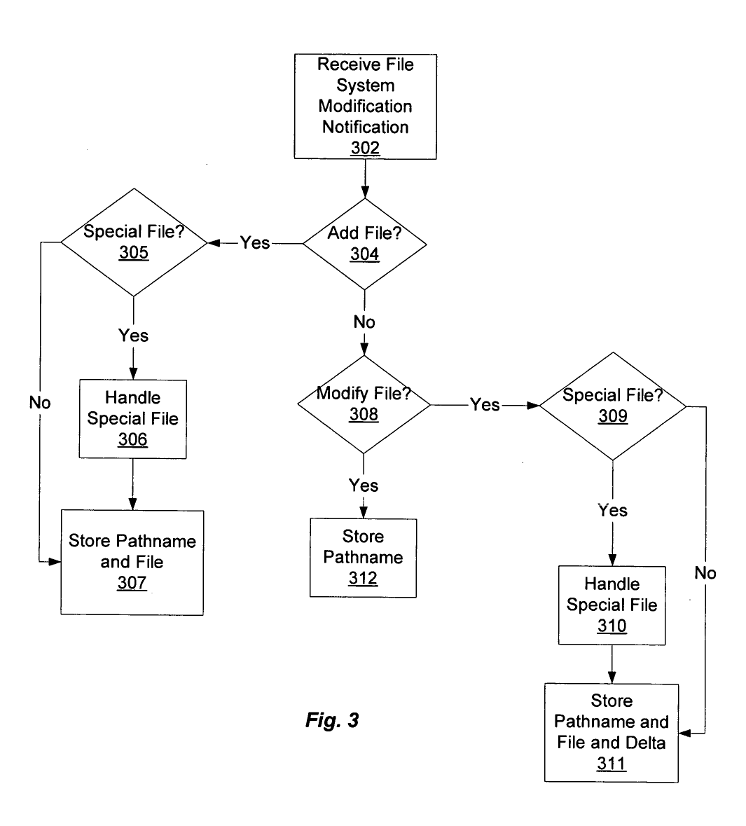

Referring now to FIG. 3, there is shown a flow chart of a method for tracking file system modifications in accordance with an embodiment of the present invention. First, modification sentry 102 receives 302 a notification of a modification to the source file system 108. If 304 the modification is an addition of a file and the file is not 305 a special file, then modification sentry 102 stores 307 the pathname and file in repository 104. If 305 the file is a special file such as a soft linked file, hard linked file, or user account file, then further processing takes place 306 prior to storing 307 the pathname and file. Further processing for special files is described further below. Alternatively, if the file system modification is a modification 308 of a file on source file system 108 and the file is not 309 a special file, modification sentry 102 stores 311 the pathname and file along with the delta between the modified and pre-modification versions of the file in repository 104. Again, if the file is a special file 309, it first undergoes 310 special file handling. Finally, if the modification is neither an addition nor a modification, it is a deletion, in which case modification sentry 102 stores 312 just the pathname in repository 104.

To apply the changes from the repository to the target file system a08, file system update engine 106 preferably creates an RPM-format package that is then executed on the target file system a08 in order to make the file system changes. RPM provides a means of deploying files as well as running a pre-installation script and a post-installation script. These scripts allow file system update engine 106 to control the deployment based upon the criteria described herein. In one embodiment, the modifications are propagated on demand. In an alternative embodiment, the file system modifications occur at scheduled intervals.

In some implementations of the present invention, it is preferable to account for special cases. For example, in the Linux file system (and in other Posix file systems as well), user account data is stored in the /etc/passwd, /etc/group and /etc/shadow files. Typically, user account data includes for each user account, a user name, a user id (uid) and group id (gid). Typically, a user account is created by calling an operation such as “useradd”. Useradd creates an entry in the user accounts data files, assigns a uid for the new user, assigns the new user to a gid (typically specified by a parameter to useradd, or assigned a value by default), and creates a home directory and associated files for the new user.

The present invention, as indicated, does not require that target file system 110 have a guaranteed initial state. To that end, there is no guarantee that a uid assigned on the source file system 108 has not already been assigned to someone else on the target file system 110. Therefore, in a preferred embodiment, if the user account data file has been modified on source file system 108, system 100 makes the corresponding modification on target file system 110 by doing the following. If a user account has been removed, then system 100 determines whether the corresponding uid on the target file system 110 matches the uid on the source file system 108. The uids preferably “match” if the uid, gid and user name are the same. If the uids match, then system 100 removes the user from the target file system 110. If the uids do not match, then the user is not removed from target file system 110 for safety reasons. If a user account has been modified, then system 100 attempts to match the uid on the target file system 100 in the same manner as just described for removing a user. If the matching uid is located, then the modification is made to the target file system's passwd file. If the matching uid is not located on the target file system, then the user account is created. Finally, if a new user has been added to the source file system 108, system 100 attempts to add a user with the same uid to target file system 110. If the uid is unavailable on the target file system 110—for example, if it has already been assigned to a different user—then system 100 adds the user with whatever uid is available, copies the user's files (as described above for moving new files to the target file system 110), and then changes the ownership and any other associated attributes on the new files such that they are owned by the uid of the user on the target file system, rather than on the source file system. Alternatively, if the uid is available on the target file system 110, then the user account is added and the files copied from the source file system 108, and no ownership change needs to be recorded.

Note also that in a file system where the password file includes shadowed passwords, the passwords are actually stored in /etc/shadow, as will be understood by those of skill in the art. Preferably in such a situation, system 100 correlates the shadowed password with the correct uid once it determines which uid is to be added/removed/modified on the target file system.

Directories

As is known in the art, a directory entry is a mapping from a file name to the physical location of the file data. In many operating systems, the physical location is known as an inode. Using system 100, directories may be added, modified or removed from the source file system just as may be regular files.

Links

System 100 also manages adding, removing and modifying both soft and hard links. As is known in the art, a soft link, also called a symbolic link, is a file having as its contents a pathname of another file. References to the symbolic link are automatically converted by the operating system to references to the pathname contained in the symbolic link. Adding, modifying or removing a symbolic link is accomplished in the same manner as with normal files. However, this is not the case for hard links. Again, as known in the art, a hard link is a physical mapping to an inode. For example, assume a first file having pathname /a/b/c. If a hard link /a/b/d to the first file /a/b/c is created, then a mapping is established from /a/b/d to the inode referenced by /a/b/c.

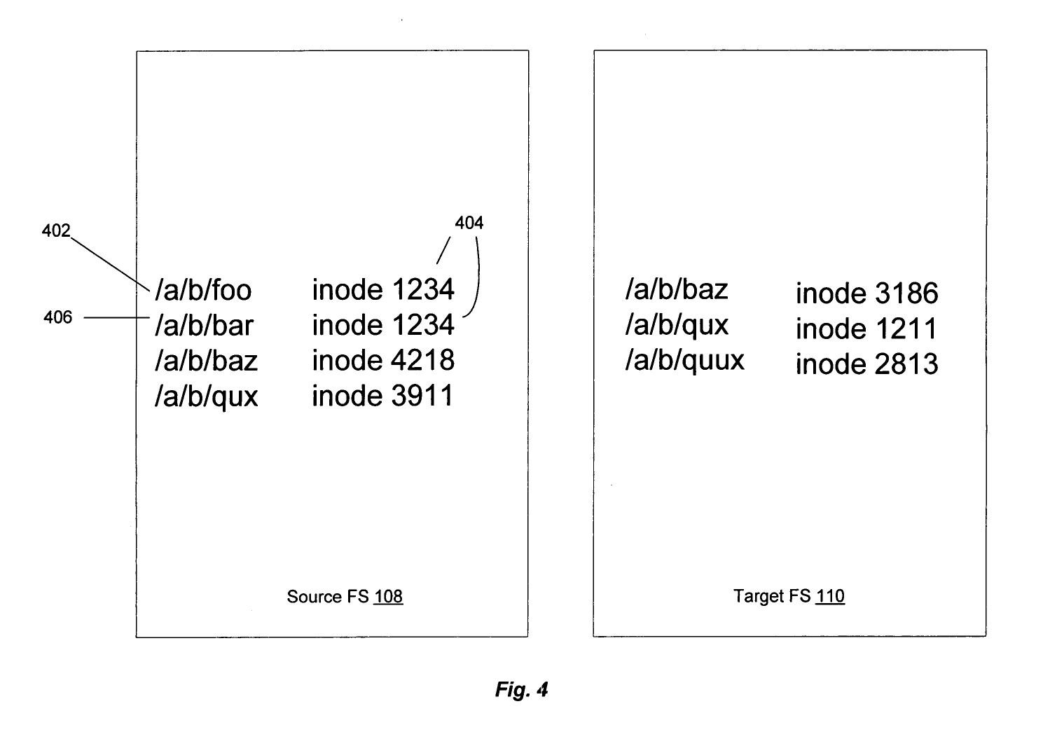

Simply copying the link, in this case /a/b/d to the target file system 110 would not be correct, because two files would then exist on the target file system 110—/a/b/c and /a/b/d, each with the same contents (but at different physical locations, i.e. different inodes). System 100 therefore preferably walks the entire directory structure and identifies the inode pointed to by each entry. If two entries point to the same inode, system 100 recognizes that one is a hard link to the other. However, if one of the files does not exist already on the target file system 110, a choice must be made. For example, and referring now to FIG. 4, the file /a/b/foo 402 on source file system points to inode 1234 404. File /a/b/bar 406 on source file system also points to inode 1234 404. System 100 has been tracking file system changes on source file system and according to repository 104 /a/b/bar 404 has been added, but no change has been made to /a/b/foo 402. System 100 compares the inodes identified by each of the files in the file system and recognizes that /a/b/foo and /a/b/bar point to the same file and therefore that /a/b/bar should be added to target file system 110 as a link to the same node pointed to by the version of /a/b/foo target file system 110. As can be seen from FIG. 4, however, /a/b/foo does not actually exist on file system 110—it may have been deleted by a user of the target file system 110, for example. Accordingly, in a preferred embodiment, system 100 simply creates /a/b/bar on target file system 110 having the same contents as on source file system 108.

An additional consideration is how to handle symbolic links to files that do not exist on target file system 110. For example, if /a/b/baz is a symbolic link to /a/b/qux, but /a/b/qux does not exist on target file system 110, system 100 in one embodiment simply creates /a/b/baz on target file system 110, allowing it to have a dangling link. In an alternative embodiment, target file system 110 also copies /a/b/qux to target file system 110, and then copies /a/b/baz as a link to the target file system's /a/b/qux.

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. For example, the particular functions of modification sentry 102 and so forth may be provided in many or one module.

Some portions of the above description present the feature of the present invention in terms of algorithms and symbolic representations of operations on information. These algorithmic descriptions and representations are the means used by those skilled in the computer file system arts to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality.

It should be borne in mind, however, that all of these and similar terms are to be associated with the appropriate physical quantities and are merely convenient labels applied to these quantities. Unless specifically stated otherwise as apparent from the present discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It is appreciated that a variety of programming languages may be used to implement the teachings of the present invention as described herein, and any references to specific languages are provided for disclosure of enablement and best mode of the present invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

1. A system for propagating modifications to a file system, the system comprising:
a modification sentry for determining modifications made to a source file system;
a data store, communicatively coupled to the modification sentry, for receiving and storing indicia of modifications made to the source file system from the modification sentry; and
a file system update engine, communicatively coupled to the data store, for propagating the modifications to the source file system indicated in the repository to at least one target file system.

2. The system of claim 1 wherein the source file system is a Linux file system.

3. The system of claim 2 wherein the at least one target file system is a Linux file system.

4. The system of claim 1 wherein the indicated modifications include file additions.

5. The system of claim 4 wherein the indicated modifications include for each added file a pathname of the added file and the added file.

6. The system of claim 1 wherein the indicated modifications include file modifications.

7. The system of claim 6 wherein the indicated modifications include for each modified file a name of the modified file, the modified file, and the modifications to the file.

8. The system of claim 1 wherein the indicated modifications include file deletions.

9. The system of claim 8 wherein the indicated modifications include for each deleted file a pathname of the deleted file.

10. A computer-implemented method for propagating modifications to a file system, the method comprising:
receiving indications of modifications to a source file system;
storing the indications of the modifications to the source file system in a data store; and
propagating the modifications indicated in the data store to at least one target file system.

11. The computer-implemented method of claim 10 wherein prior to receiving indications of modifications to the source file system, the source file system is in a first state; and
wherein the at least one target file system is not in the first state.

12. The computer-implemented method of claim 10 wherein the modifications to the source file system include addition of a file to the source file system.

13. The computer-implemented method of claim 10 wherein the modifications to the source file system include modification of a file on the source file system.

14. The computer-implemented method of claim 10 wherein the modifications to the source file system include removing a file from the source file system.

15. A computer program product for propagating modifications to a file system, the computer program product stored on a computer readable medium and including instructions to cause a computer to carry out the steps of:
receiving indications of modifications to a source file system;
storing the indications of the modifications to the source file system in a data store; and
propagating the modifications indicated in the data store to at least one target file system.

16. The computer program product of claim 15 wherein prior to receiving indications of modifications to the source file system, the source file system is in a first state; and
wherein he at least one target file system is not in the first state.

17. The computer program product of claim 15 wherein the modifications to the source file system include addition of a file to the source file system.

18. The computer program product of claim 15 wherein the modifications to the source file system include modification of a file on the source file system.

19. The computer program product of claim 15 wherein the modifications to the source file system include removing a file from the source file system.
